(19) United States
(12) Patent Application Publication
(10) Pub. No.: US 2024/0241870 A1
(43) Pub. Date: Jul. 18, 2024

(54) RESOURCE AWARE DATA MINING AND ANALYSIS

(71) Applicant: INTERNATIONAL BUSINESS MACHINES CORPORATION, Armonk, NY (US)

(72) Inventors: Fan Jing MENG, Beijing (CN); Xing TIAN, Beijing (CN); Cheng Fang WANG, Shangdi (CN); Hua YE, Beijing (CN); Li Jian WANG, Beijing (CN)

(21) Appl. No.: 18/154,985

(22) Filed: Jan. 16, 2023

(51) Int. Cl. G06F 16/21; G06F 16/28

(52) U.S. Cl. CPC G06F 16/219; G06F 16/289

(57) ABSTRACT

Computer implemented method, systems, and computer program products include program code executing on a processor(s) monitors objects in the technical environment to collect real-time operational data. The program code obtains historical operational data and historical resource data from the technical environment and generates models to evaluate health states and resource states of the one or more objects. The program code applies the models and identifies objects as abnormal. The program code obtains a topology of the technical environment to identify objects impacted by the abnormal object(s). The program code generates a resource aware dynamic operational data collection plan.

### BACKGROUND

The present invention relates generally to the field of technical infrastructure management and more particularly to automatically generating and implementing a resource aware dynamic operational data collection and analysis plan in a technical environment

The complexity of modern Information Technology (IT) continues to increase over time due to the increasing intricacy of technical environments. A technical infrastructure can include an ever-increasing number of managed objects (scale of managed objects has increased due to hybrid loud infrastructures in technical environments), clouds/virtualization, distributed systems, and a heterogeneous architecture. Additionally, users of the technical infrastructure can often require 24/7 availability for the technical architecture. In managing modern technical environments, various tools can collect operational data, providing visibility into various aspects of the technical architecture. Due to the complexity of the environments, operational data can be collected from the full stack (e.g., hardware, operating system (OS), virtualization layer, middleware, applications, third party services, etc.). These operational data collected can include, but are not limited to, monitoring, logs, events, tickets, and trace (request) data. Tools collect a large amount of data which, to gain intelligence about the technical environment, the tools collect, store, and analyze. The complexity of managing these data is increased as the ratio of unstructured to structured operational data changes with the amount of the former increasing. The quantity of the data produced, and collected, stored, and analyzed by existing tools presents an overhead challenge in existing IT environments.

### SUMMARY

Shortcomings of the prior art are overcome, and additional advantages are provided through the provision of a computer-implemented method for automatically generating and implementing a resource aware dynamic operational data collection and analysis plan in a technical environment. The computer-implemented method includes: monitoring, by one or more processors, one or more objects comprising the technical environment, to collect real-time operational data of the one or more objects; obtaining, by the one or more processors, historical operational data of the technical environment and historical resource data of the technical environment, wherein the historical operational data and the historical resource data were generated by the one or more objects; generating, by the one or more processors, based on the historical operational data and the historical resource data, one or more models to evaluate health states and resource states of the one or more objects; applying, by the one or more processors, the models to the real-time operational data of the one or more objects to determine health states and resource states for the one or more objects, wherein the applying comprises identifying at least one object of the one or more objects as abnormal based on the health states or the resource states; obtaining, by the one or more processors, a topology of the technical environment; utilizing, by the one or more processors, the topology to identify a subset of the one or more objects which are impacted by the at least one object based on the topology; and generating, by the one or more processors, the resource aware dynamic operational data collection plan based on the identified subset of the one or more objects.

Shortcomings of the prior art are overcome, and additional advantages are provided through the provision of a computer program product for automatically generating and implementing a resource aware dynamic operational data collection and analysis plan in a technical environment. The computer program product comprises a storage medium readable by a one or more processors and storing instructions for execution by the one or more processors for performing a method. The method includes, for instance: monitoring, by the one or more processors, one or more objects comprising the technical environment, to collect real-time operational data of the one or more objects; obtaining, by the one or more processors, historical operational data of the technical environment and historical resource data of the technical environment, wherein the historical operational data and the historical resource data were generated by the one or more objects; generating, by the one or more processors, based on the historical operational data and the historical resource data, one or more models to evaluate health states and resource states of the one or more objects; applying, by the one or more processors, the models to the real-time operational data of the one or more objects to determine health states and resource states for the one or more objects, wherein the applying comprises identifying at least one object of the one or more objects as abnormal based on the health states or the resource states; obtaining, by the one or more processors, a topology of the technical environment; utilizing, by the one or more processors, the topology to identify a subset of the one or more objects which are impacted by the at least one object based on the topology; and generating, by the one or more processors, the resource aware dynamic operational data collection plan based on the identified subset of the one or more objects.

Shortcomings of the prior art are overcome, and additional advantages are provided through the provision of a system for automatically generating and implementing a resource aware dynamic operational data collection and analysis plan in a technical environment. The system includes: a memory, one or more processors in communication with the memory, and program instructions executable by the one or more processors via the memory to perform a method. The method includes, for instance: monitoring, by the one or more processors, one or more objects comprising the technical environment, to collect real-time operational data of the one or more objects; obtaining, by the one or more processors, historical operational data of the technical environment and historical resource data of the technical environment, wherein the historical operational data and the historical resource data were generated by the one or more objects; generating, by the one or more processors, based on the historical operational data and the historical resource data, one or more models to evaluate health states and resource states of the one or more objects; applying, by the one or more processors, the models to the real-time operational data of the one or more objects to determine health states and resource states for the one or more objects, wherein the applying comprises identifying at least one object of the one or more objects as abnormal based on the health states or the resource states; obtaining, by the one or more processors, a topology of the technical environment; utilizing, by the one or more processors, the topology to identify a subset of the one or more objects which are impacted by the at least one object based on the topology; and generating, by the one or more processors, the resource aware dynamic operational data collection plan based on the identified subset of the one or more objects.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a block diagram that illustrates various aspects of some embodiments of the present invention;

FIG. 3 illustrates some aspects of the certain functionalities of various embodiments of the present invention;

FIG. 4 illustrates some aspects of the certain functionalities of various embodiments of the present invention;

FIG. 5 depicts a workflow that illustrates various aspects of some embodiments of the present invention;

FIG. 6 illustrates some aspects of the certain functionalities of various embodiments of the present invention; and

FIG. 7 depicts one example of a machine learning training system used in accordance with one or more aspects of the present invention.

### DETAILED DESCRIPTION

In existing IT infrastructures, various tools collect, store, and analyze operational data in order to gain insight into the operation of the systems that comprise the infrastructure. As aforementioned, among the data collected are data from the full stack (e.g., hardware, operating system (OS), virtualization layer, middleware, applications, third party services, etc.). For example, various tools can collect monitoring operation data, which can include but is not limited to time-series numeric data (e.g., <timestamp, measurement, value>) taken at various sampling intervals (e.g., 1 s/10 s/1 m/5 m/10 m). These operational data can also include logs, which are time-series based semi-structural data (e.g., <timestamp, source, log-Level, textual log message>). Operational data can also include events, which are time-series based semi-structural data (e.g., <timestamp, source, severity, situation, textual event message>. Operational data can also include tickets, which are time-series based semi-structural data (e.g., <open-timestamp, severity, type, owner, status, symptom, root cause, resolution, close-timestamp>). Requests are also operational data and are time-series based semi-structural data (e.g., <timestamp, type, status, textual change message, change impact, change window, rollback solution>). Data types that can comprise operational data can include, but are not limited to, Apache Logs, SystemOut logs. Linux Syslogs, MF Syslogs, Sources, z/OS, and z/Linux.

As aforementioned, with modern IT systems, the amount of operational data that tools handle to provide insights into the systems is ever-expanding and presents overheard challenges. The complexity of managing these data is increased as the ratio of unstructured to structured operational data changes with the amount of the former increasing. To understand the volume of data collected for storage and analysis, one can note that various tools can collect 20 terra bytes (TB) of operational data from a technical environment that includes more than 2,000 servers executing more than 100 applications. The tools collect a large amount of data to gain intelligence about the systems. Generally, a large-scale operational data platform collects, processes, stores, visualizes, analyzes, and/or archives these data.

An operational data collection and management system can be seen as overhead to business workloads as it does not contribute to any business transactions. However, this collection (and analysis) is essential to system management and maintenance because these data are utilized in problem prediction, diagnosis, and/or operations to ensure system's reliability. Thus, there is a balance between overheard (in order not to negatively impact core functionality) and benefits of collecting and processing operational data, which can ensure the health of a technical infrastructure. Thus, it is desirable to limit the volume of data collected while still collecting enough data to optimize system health. Current approaches to limiting the amount of data collected are not effective in maintaining this balance. For example, utilizing approaches including but not limited to pre-configured profiles, configuration files, scripts, parameters, etc. to collect pre-defined operational data leads to collecting more data than needed. Also, these approaches do not differentiate whether the data they collect is normal or abnormal and thus, waste resources.

Embodiments of the present invention provide a resource-aware operational data collection method that considers various aspects that positively impact the health of the environment. First, in the method described herein, program code executing on at least one processor is resource-aware, meaning that the program code determines a scope of operational data to collect in the context of available resources (e.g., power, bandwidth, space, compute, cost, carbon, etc.). The program code also considers the state of monitored objects by distinguishing the state of whole monitored environments and identifying abnormal components of the systems. Finally, the program code in the examples herein makes data collection decisions based on topology because the program code determines a potential fault propagation and/or impact based on determining the topology of the systems and/or the environment. In embodiments of the present invention, the program code generates and can implement an operational data collection program based on a real-time understanding of the technical environment in which the collection is to be implemented. This approach not only streamlines the data collected by the program code but also identifies operational data for collection that will enable a higher percentage (when compared with existing methods) of data collected to be relevant to problem prediction, diagnosis, and/or operations. Thus, the examples disclosed herein balance the productivity and efficiency of the system's core functions with maintaining the stability of the technical environment (based on processes involving operational data).

Embodiments of the present invention are inextricably tied to computing and are directed to a practical application. The examples described herein are inextricably linked to computing as the examples herein provide systems, methods, and computer program products that maintain and manage ever evolving and expanding computing infrastructures (which leads to improved performance of the subject systems). In some examples, program code (including program code comprising decision models) evaluates the health state and resource state of monitored objects in a technical environment based on real-time operational data from the environment and the models, determines, from the monitored objects, which components are abnormal, determines impacts of these abnormalities, and determines and implements an operational data collection strategy in the technical environment. At least because the program code generates and implements operations in a technical environment and these operations improve the functioning of the computing resources within the technical environment (as well as the systems therein and the environment as a whole), the examples herein are not only inextricably tied to computing, they also are directed to the practical application of improving the functionality of resources in a computing environment by balancing operational data collection with core system functionality to enable both real-time efficiency of the systems as well as maintaining the health of the resources that are responsible for these core functionalities.

Embodiments of the present invention provide significantly more than existing operational data collection techniques. Some existing systems utilize pre-defined configuration files and profiles to collect operational data, which can result in the collection of irrelevant (to maintaining system health) data and increased overhead. In contrast, because the examples herein utilize resource awareness and generate operations, including configuration files and profiles, responsive to real-time resource awareness, the examples herein will collect more relevant data and hence, decrease overheard and efficacy of the overall systems as well as provide an improved solution for resource health maintenance. Existing techniques, which range from offline log collectors or run-time log collectors that collect logs, from pre-configured log files, local collectors pre-configured to send monitoring data to aggregators, and method of monitoring, analyzing and optimizing and controlling data centers (after data collection is complete) do not include the resource awareness aspects of the examples herein. By integrating resource awareness into operational data collection for improved systems maintenance, the examples herein provide significantly more than these existing approaches.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

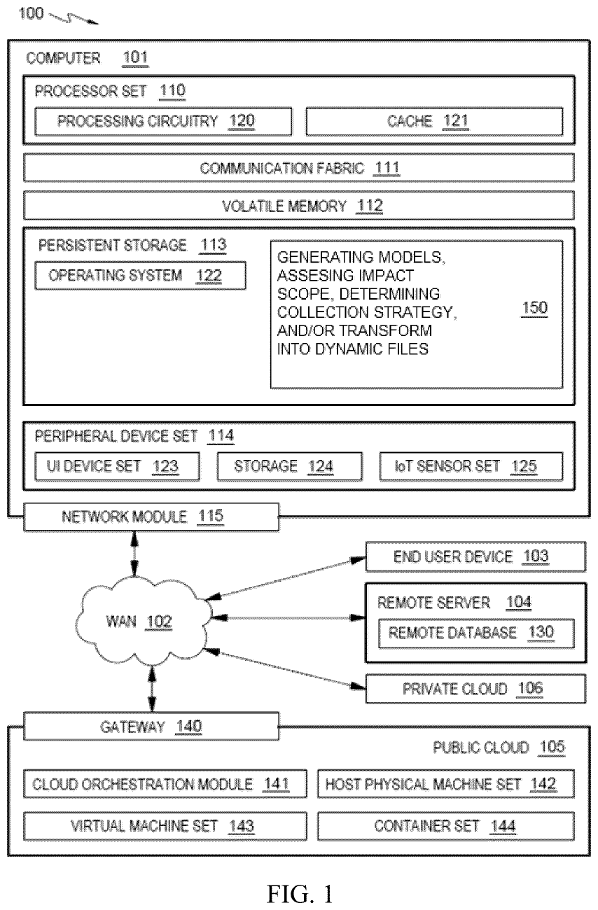

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as a code block for generating health and resource models to monitor objects, evaluating a state of health of the resources, assess an impact scope of an abnormal resource, determining an operational data collection strategy, and/or transforming the strategy into dynamic files for data collection 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

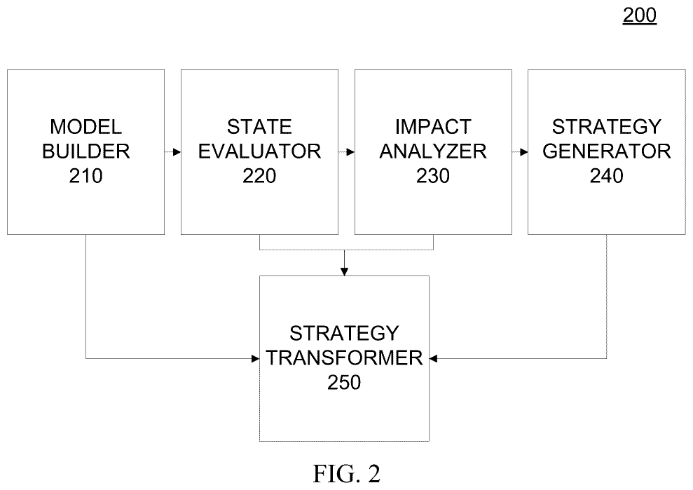

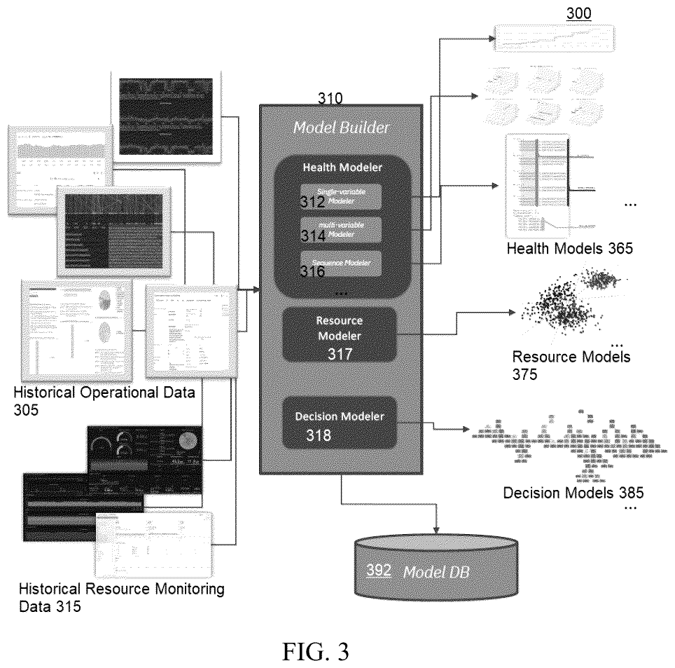

FIGS. 2-7 illustrate various aspects of some embodiments of the present invention. While FIG. 2 illustrates an overview of various aspects, FIGS. 3-6 provide additional detail for certain of the aspects illustrated and discussed in describing FIG. 2.

FIG. 2 provides a block diagram 200 that illustrates various aspects of some embodiments of the present invention. In FIG. 2, different functionalities provided by the program code (executing on one or more processors) are separated into different blocks which can represent different modules. However, this separation is provided for illustrative purposes only and not to imply any limitations. These modules can comprise software and/or hardware. The functionalities can be contained in any number of modules including being combined in one or more modules.

Monitored objects within a technical infrastructure include computing resources comprising the infrastructure at all layers of the stack. The program code collects operational data from one or more of the monitored objects in the examples herein. In FIG. 2, the program code includes a model builder 210 module. The program code comprising the model builder 210 obtains historical operational data and resource data (e.g., power, bandwidth, space, computing, cost, carbon, etc.), to generate health models and resource models of monitored objects in a technical environment. The program code of the model building 210 also generates decision models of data collection based on health states and resource states of resources within a technical architecture. Utilizing the models generated by the program code comprising the model builder, program code in a state evaluator 220 module evaluates the health state and resource state of monitored objects based on real-time operational data and the aforementioned health models. The program code of the state evaluator 220, based on utilizing the health models and monitoring the objects determines, from the monitored objects, which components are abnormal (e.g., operating outside of expected parameters of the applied model(s)). Program code of an impact analyzer 230 obtains both a topology for the technical environment and the abnormal component determinations and based on the topology, the program code assesses an impact scope of the abnormal components on the technical infrastructure. Program code comprising a strategy generator 240 module obtains results from the model building 210, state evaluator 220, and impact analyzer 230 modules and utilizes these results to determine an operational data collection strategy, including but not limited to, scope, granularity, and/or frequency of this collection effort. Program code of a strategy transformer 250 module transforms the strategy into a program and can implement the program in the technical environment. The program generated by the program code of the strategy transformer 250 includes, but is not limited to profiles, configuration files, scripts, parameters, etc. for use by data collectors within the technical environment.

FIG. 3 depicts aspects of the functionality 300 of the model builder 310, 210 portion of the examples herein. As illustrated in FIG. 3, the program code obtains historical operational data 305 and historical resource monitoring data 315 and outputs one or more health models 365, one or more resources models 375, and one or more decision models 385. For ease of understanding, the depiction of the program code is separated by functionality. This configuration is indicative of a possible technical architecture and offered merely for illustrative purposes and not to suggest any limitations. In this example, the program code of the model builder 310 is separated into a health modeler 311, a resources modeler 317, and a decision modeler 318.

The program code generates health models 365 utilizing the historical data (e.g., the historical operational data 305 and/or the historical resource monitoring data 315). The program code (e.g., of the health modeler 311) can generate at least three different types of health models 365, single-variable models, multi-variable models, and sequence models (e.g., utilizing a health modeler 311). The program code that generates these different types of models need not be separate but is depicted as such for illustrative purposes only. Thus, in embodiments of the present invention, the program code (e.g., of a single variable modeler 312) generates single variable health models by obtaining a single variable measurement (from the historical data) and building a regression model with machine learning and/or deep learning and utilizes a type of neural network. For example, the program code may utilize an autoregressive integrated moving average, a long short-term memory neural network, and/or a recurrent neural network.

In some embodiments of the present invention, the program code performs a regression to generate a health model by utilizing a machine learning system that includes a neural network (NN). In certain embodiments of the present invention the program code utilizes supervised, semi-supervised, or unsupervised deep learning through a single- or multi-layer NN to correlate various attributes from unstructured and structured data from the historical data. The program code utilizes resources of the NN to identify and weight connections from the attribute sets in the data gathered. For example, the NN can identify certain data that are indicative of performance metrics of various resources that are outside of an expected range. In this way, the program code can generate a model that can classify resources as operating normally and/or abnormally, in real-time, based on utilizing patterns that the program code identifies in the historical data.

As understood by one of skill in the art, neural networks are a biologically inspired programming paradigm that enable a computer to learn from diverse data sets, including historical operational data 305 and historical resource monitoring data 315. This learning is referred to as deep learning, which is a set of techniques for learning in neural networks. Neural networks, including modular neural networks, are capable of pattern recognition with speed, accuracy, and efficiency, in a situation where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning both provide assistance in parsing both structures and unstructured data across multiple resources in a technical environment. Thus, by utilizing an NN, the program code can identify attributes and classify these attributes as indicative of the efficacy of the operation of different resources and different types of resources.

The program code can also utilize machine and deep learning as well as a neural network to generate multi-variable models (e.g., utilizing a multi-variable modeler 314). The program code obtains multi-variant measurements which the program code clusters into cluster models utilizing machine learning or deep learning (the historical data acts as training data to train the models). The program code can utilize various existing techniques to cluster the measurements into a model. For example, the program code can perform k-means clustering as a method of vector quantization to partition n measurements into k clusters in which each observation belongs to the cluster with the nearest mean, serving as a prototype of the cluster. The program code can also utilize hierarchical clustering to build a hierarchy of clusters to generate the models. These examples, which also include AE, are non-limiting and merely provided for illustrative purposes. In these examples, each cluster forms a steady state.

The program code can also utilize machine and deep learning as well as a neural network to generate multi-sequence models (e.g., utilizing a sequence modeler 316). The program code obtains a set of sequences (e.g., log transaction sequences, event sequences, ticket sequences) and extracts frequent sequences from the set and calculates significant variables (e.g., utilizing machine learning and deep learning). The program code can mine the data for these values utilizing known techniques including but not limited to, Apriori and/or FP-Tree (frequent pattern tree) and/or FP-growth (frequent pattern growth).

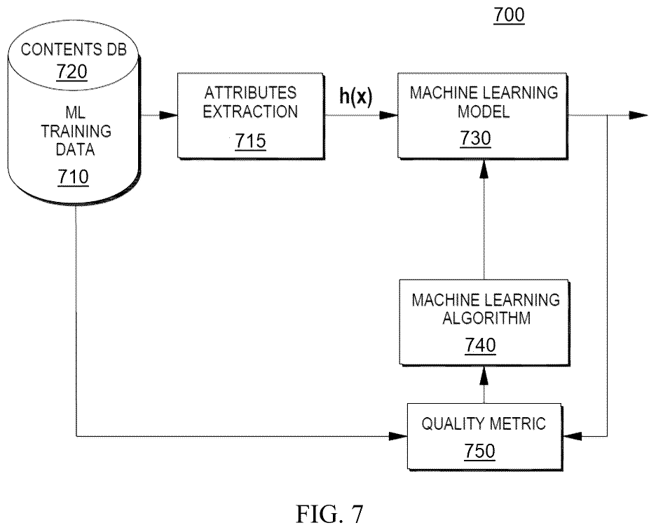

The program code also utilizes historical data (e.g., the historical operational data 305 and/or the historical resource monitoring data 315) to build one or more resource models 375. The resource models can be utilized by the program code to determine the status of various resources in a technical environment. The program code (e.g., the resource modeler) obtains the historical resource data, including consumption metrics, to build classification and/or clustering models to determine the resource consumption states of resources in the system, in real-time. FIG. 7 is an example of the classifier that can be generated by the program code.

The program code generates and trains a model on? resources, including based on consumption metrics, to identify abnormalities, in a technical architecture. FIG. 7 is one example of a machine learning training system 700 that may be utilized, in one or more aspects, to generate and train resource models that can identify resource consumption and hence, identify resources as operating outside of an expected range. In some examples, this machine learning training system 700 is also relevant to the health models 365 and the decision models 385 generated by the program code but is discussed in the context of the resource model 375 for illustrative purposes. The program code can be trained to classify resources as either normal or abnormal, based on various status indicators, including but not limited to, consumption. FIG. 7 is one example of a machine learning training system 700 that may be utilized, in one or more aspects, to perform cognitive analyses of various inputs, including historical data (e.g., the historical operational data 305 and/or the historical resource monitoring data 315). The program code in embodiments of the present invention performs a cognitive analysis to generate one or more training data structures, including the resource models 375, which can include algorithms utilized by the program code to classify a resource based on performance. Machine learning (ML) solves problems that are not solved with numerical means alone. In this ML-based example, program code extracts various attributes from ML training data (e.g., the historical operational data 305 and/or the historical resource monitoring data 315). Attributes 715 are utilized to develop a predictor or classifier function, h(x), also referred to as a hypothesis, which the program code utilizes as a machine learning model 730.

In identifying various resource types, features and/or parameters indicative of product types in the ML training data 710, the program code can utilize various techniques to identify attributes in an embodiment of the present invention. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various events. The program code may utilize a machine learning algorithm 740 to train the machine learning model 730 (e.g., the algorithms utilized by the program code), including providing weights for the conclusions, so that the program code can train the predictor functions that comprise the machine learning model 730. The conclusions may be evaluated by a quality metric 750. By selecting a diverse set of ML training data 710, the program code trains the machine learning model 730 to identify and weight various attributes (e.g., features, patterns, components) that correlate to resource types.

The model generated by the program code can be self-learning as the program code updates the model based on active event feedback, as well as from the feedback received from data related to the event. For example, when the program code determines that there is information that was not previously predicted or classified by the model, the program code utilizes a learning agent to update the model to reflect the resource type, to improve classifications in the future. Additionally, when the program code determines that a classification is incorrect, either based on receiving user feedback through an interface or based on monitoring related to the event, the program code updates the model to reflect the inaccuracy of the classification for the given period of time. Program code comprising a learning agent cognitively analyzes the data deviating from the modeled expectations and adjusts the model to increase the accuracy of the model, moving forward.

Program code comprising a resource modeler 317 (which is part of the model builder 310) generates resource models 375 based on obtaining statuses for resources. The program code determines the status of the resources based on obtaining consumption metrics and this, the resource models 375 include classification and/or clustering models that determine resource consumption rates. Program code comprising a decision modeler 318 generates decision models 385. The decision models 385 can be understood as data collection decision models because they are also generated by the program code based on a state of health and resource status. In some examples, the program code obtains health and resource status from a system resource (e.g., a monitored object). The program code can build one or more decision tree models based on historical operational data and resource monitoring data. The program code obtains the historical operational data 305 as well as the resource monitoring data and outputs the health models 365, resources models 375, and decision models 385, which is in a model database 392.

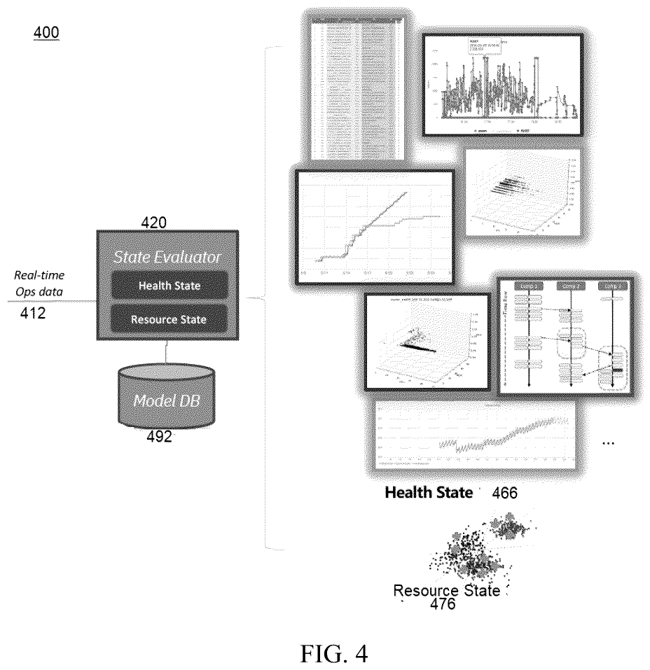

FIG. 4 is an example of functionality 400 of program code comprising the state evaluator 420 (e.g., FIG. 2, 220). The program code comprising the state evaluator 440 obtains, as input, real-time operational data and evaluates the state of the system (e.g., based on the health models 365, resources models 375, and decision models 385 stored in the model database 492). The program code of the state evaluator 420 outputs, upon determining the states of resources, health states 466 of the monitored objects (resources) and resource states 476 of monitored objects. In some examples, the program code represents the health state of a monitored object as normal or abnormal. In some examples, the program code represents the resource state of a monitored objects as low, medium, or high. The thresholds for these settings can be pre-configured by an administrator. The program code of the state evaluator 420 obtains real-time data 412 (based on monitoring the objects) and fits these data to the models (e.g., health models 365, resources models 375, and decision models 385). The program code evaluates the health state 466 of the objects with the health models (e.g., single-variable models, multi-variable models, and/or sequence models). The program code utilizes the resource models to evaluate the resource state 476 of the objects. The program code exports the states (e.g., health state 466, resource state 476).

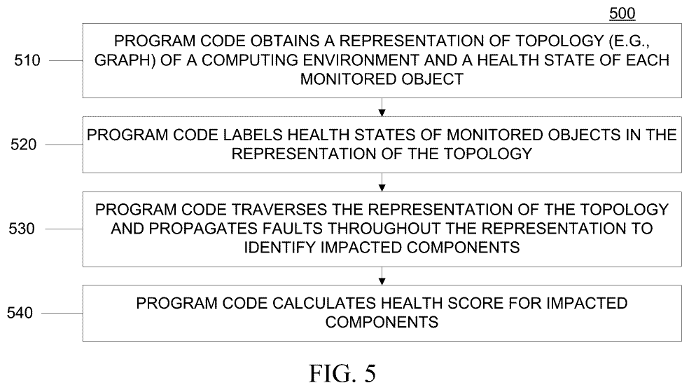

FIG. 5 is a workflow 500 that illustrates the functionality of program code comprising the impact analyzer (e.g., FIG. 2, 230) in certain of the examples herein. As illustrated, the program code (e.g., of the of the impact analyzer) obtains, as inputs, the health states (generated by the program code as illustrated in FIG. 4), and a representation of the topology of the computing environment (510). Ultimately, the program code of the impact analyzer outputs can include identifications of impacted components and failure scores for these components. However, based on obtaining the health scores and the representation of the topology of the system (e.g., a graph), the program code labels health states of the monitored objects in the representation (520). For example, the program code can assign a fault score of “1” to an object if the heath state is abnormal and “0” if it is normal. This scoring is merely one example but the program code, by labeling the objects, differentiates objects with abnormal or unexpected states from those with normal or expected states. The program code performs an analysis of the propagation (of the health scores) in the representation (e.g., graph). The program code can utilize an existing method for this analysis, including various graph analysis algorithms such as Page Rank. Based on this analysis, in which the program code identifies impacted components (530), the program code calculates health scores for the impacted components (540). In the analysis, the program code determines the impact paths for various objects and in this manner, identifies the impacted components.

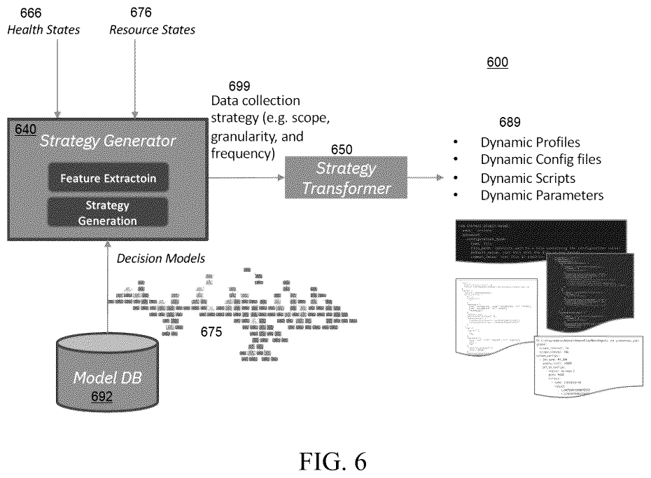

FIG. 6 illustrates functionality 600 of program code comprising both the strategy generator 640 and the strategy transformer 650 (e.g., FIG. 2, 240, 250). The program code comprising the strategy generator 640 obtains health states 666, resource states 676, and the resources monitoring data (including the models, including the decision models 675 stored in the model database 692). The program code utilizes these inputs, ultimately, to generate elements 689 that comprise the data collection strategy 699, for the computing environment. The elements 689 can include dynamic profiles, dynamic configuration files, dynamic scripts, and/or dynamic parameters. The strategy 699 dictates the scope, frequency, and/or granularity of the data collection within the computing environment and the dynamic profiles, dynamic configuration files, dynamic scripts, and/or dynamic parameters enact this plan. The program code of the strategy transformer 650 transforms the data collection plan strategy 699 into the elements 689. In order to generate the data collection strategy 699, the program code categorizes monitored objects based on their fault scores (e.g., high, medium, and/or low). In some examples, the program code, for each category of monitored objects (based on fault score groupings), obtains real-time resource monitoring data, applies the decision model(s) 675 to determine data collection variables (e.g., whether and how to collect, the frequency at which to collect, the granularity of the data to collect, etc.). For example, for a low fault object, the program code may collect data infrequently, not at all, or with little granularity. For a high risk object, the program code can implement a different strategy. The program code of the strategy transformer 650 transforms the data collection strategies for the object into elements including dynamic configuration file (e.g., profiles, configuration files, scripts, and/or parameters/etc.) for given data collectors (without the computing environment). Thus, the program code can determine a strategy for collection as well as assign resources to collect data from various objects.

Embodiments herein include computer-implemented methods, computer systems, and computer program products that include program code executing on one or more processors that automatically generate and implement a resource aware dynamic operational data collection and analysis plan in a technical environment. In some examples, the program code monitors one or more objects comprising the technical environment, to collect real-time operational data of the one or more objects. The program code obtains historical operational data of the technical environment and historical resource data of the technical environment, where the historical operational data and the historical resource data were generated by the one or more objects. The program code generates, based on the historical operational data and the historical resource data, one or more models to evaluate health states and resource states of the one or more objects. The program code applies the models to the real-time operational data of the one or more objects determine health states and resource states for the one or more objects, where the applying comprises identifying at least one object of the one or more objects as abnormal based on the health states or the resource states. The program code obtains a topology of the technical environment. The program code utilizes the topology to identify a subset of the one or more objects which are impacted by the at least one object based on the topology. The program code generates the resource aware dynamic operational data collection plan based on the identified subset of the one or more objects.

In some examples, the resource aware dynamic operational data collection comprises elements selected from the group consisting of: dynamic profiles, dynamic configuration files, dynamic scripts, and dynamic parameters.

In some examples, the models are selected from the group consisting of: health models and resource models.

In some examples, the real-time operational data, the historical operational data, and the historical resource data are selected from the group consisting of power, bandwidth, space, computing, cost, and carbon footprint.

In some examples, identifying the at least one object of the one or more objects as abnormal comprises determining that the at least one object is operating outside of expected parameters of a model of the one or more models.

In some examples, generating the one or more models to evaluate health states and resource states of the one or more objects comprises utilizing the historical operational data and the historical resource data to establish the expected parameters.

In some examples, utilizing the topology to identify the subset of the one or more objects which are impacted by the at least one object comprises determining an impact scope of the at least one object.

In some examples, the dynamic operational data collection plan includes parameters selected from the group consisting of: scope, frequency, and granularity of data collection.

In some examples, the program code automatically generates, based on the resource aware dynamic operational data collection plan, command files to implement the resource aware dynamic operational data collection plan within the technical environment.

In some examples, the program code deploys the command files to the technical environment.

In some examples, the program code automatically implements the command filed in the technical environment.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of automatically generating and implementing a resource aware dynamic operational data collection and analysis plan in a technical environment, the method comprising:
monitoring, by one or more processors, one or more objects comprising the technical environment, to collect real-time operational data of the one or more objects;
obtaining, by the one or more processors, historical operational data of the technical environment and historical resource data of the technical environment, wherein the historical operational data and the historical resource data were generated by the one or more objects;
generating, by the one or more processors, based on the historical operational data and the historical resource data, one or more models to evaluate health states and resource states of the one or more objects;
applying, by the one or more processors, the models to the real-time operational data of the one or more objects to determine health states and resource states for the one or more objects, wherein the applying comprises identifying at least one object of the one or more objects as abnormal based on the health states or the resource states;
obtaining, by the one or more processors, a topology of the technical environment;
utilizing, by the one or more processors, the topology to identify a subset of the one or more objects which are impacted by the at least one object based on the topology; and
generating, by the one or more processors, the resource aware dynamic operational data collection plan based on the identified subset of the one or more objects.

2. The computer-implemented of claim 1, wherein the resource aware dynamic operational data collection comprises elements selected from the group consisting of: dynamic profiles, dynamic configuration files, dynamic scripts, and dynamic parameters.

3. The computer-implemented method of claim 1, wherein the models are selected from the group consisting of: health models and resource models.

4. The computer-implemented method of claim 1, wherein the real-time operational data, the historical operational data, and the historical resource data are selected from the group consisting of power, bandwidth, space, computing, cost, and carbon footprint.

5. The computer-implemented method of claim 1, wherein identifying the at least one object of the one or more objects as abnormal comprises determining that the at least one object is operating outside of expected parameters of a model of the one or more models.

6. The computer-implemented method of claim 6, wherein generating the one or more models to evaluate health states and resource states of the one or more objects comprises utilizing the historical operational data and the historical resource data to establish the expected parameters.

7. The computer-implemented method of claim 1, wherein utilizing the topology to identify the subset of the one or more objects which are impacted by the at least one object comprises determining an impact scope of the at least one object.

8. The computer-implemented method of claim 1, wherein the dynamic operational data collection plan includes parameters selected from the group consisting of: scope, frequency, and granularity of data collection.

9. The computer-implemented method of claim 1, further comprising:
automatically generating, by the one or more processors, based on the resource aware dynamic operational data collection plan, command files to implement the resource aware dynamic operational data collection plan within the technical environment.

10. The computer-implemented method of claim 9, further comprising:
deploying, by the one or more processors, the command files to the technical environment.

11. The computer-implemented method of claim 9, further comprising:
automatically implementing, by the one or more processors, the command filed in the technical environment.

12. A computer system for automatically generating and implementing a resource aware dynamic operational data collection and analysis plan in a technical environment, the computer system comprising:
a memory; and
one or more processors in communication with the memory, wherein the computer system is configured to perform a method, said method comprising:
monitoring, by the one or more processors, one or more objects comprising the technical environment, to collect real-time operational data of the one or more objects;
obtaining, by the one or more processors, historical operational data of the technical environment and historical resource data of the technical environment, wherein the historical operational data and the historical resource data were generated by the one or more objects;
generating, by the one or more processors, based on the historical operational data and the historical resource data, one or more models to evaluate health states and resource states of the one or more objects;
applying, by the one or more processors, the models to the real-time operational data of the one or more objects to determine health states and resource states for the one or more objects, wherein the applying comprises identifying at least one object of the one or more objects as abnormal based on the health states or the resource states;
obtaining, by the one or more processors, a topology of the technical environment;
utilizing, by the one or more processors, the topology to identify a subset of the one or more objects which are impacted by the at least one object based on the topology; and
generating, by the one or more processors, the resource aware dynamic operational data collection plan based on the identified subset of the one or more objects.

13. The computer system of claim 12, wherein the resource aware dynamic operational data collection comprises elements selected from the group consisting of: dynamic profiles, dynamic configuration files, dynamic scripts, and dynamic parameters.

14. The computer system of claim 12, wherein the models are selected from the group consisting of: health models and resource models.

15. The computer system of claim 12, wherein the real-time operational data, the historical operational data, and the historical resource data are selected from the group consisting of power, bandwidth, space, computing, cost, and carbon footprint.

16. The computer system of claim 12, wherein identifying the at least one object of the one or more objects as abnormal comprises determining that the at least one object is operating outside of expected parameters of a model of the one or more models.

17. The computer system of claim 12, the method further comprising:
automatically generating, by the one or more processors, based on the resource aware dynamic operational data collection plan, command files to implement the resource aware dynamic operational data collection plan within the technical environment.

18. The computer system of claim 17, further comprising:
deploying, by the one or more processors, the command files to the technical environment; or
automatically implementing, by the one or more processors, the command filed in the technical environment.

19. The computer-implemented method of claim 9, further comprising:
automatically implementing, by the one or more processors, the command filed in the technical environment.

20. A computer program product for automatically generating and implementing a resource aware dynamic operational data collection and analysis plan in a technical environment, the computer program product comprising:
one or more computer readable storage media and program instructions collectively stored on the one or more computer readable storage media readable by at least one processing circuit to perform a method comprising:
monitoring, by the one or more processors, one or more objects comprising the technical environment, to collect real-time operational data of the one or more objects;
obtaining, by the one or more processors, historical operational data of the technical environment and historical resource data of the technical environment, wherein the historical operational data and the historical resource data were generated by the one or more objects;
generating, by the one or more processors, based on the historical operational data and the historical resource data, one or more models to evaluate health states and resource states of the one or more objects;
applying, by the one or more processors, the models to the real-time operational data of the one or more objects to determine health states and resource states for the one or more objects, wherein the applying comprises identifying at least one object of the one or more objects as abnormal based on the health states or the resource states;
obtaining, by the one or more processors, a topology of the technical environment;
utilizing, by the one or more processors, the topology to identify a subset of the one or more objects which are impacted by the at least one object based on the topology; and
generating, by the one or more processors, the resource aware dynamic operational data collection plan based on the identified subset of the one or more objects.
